(19) United States
(12) Patent Application Publication
(10) Pub. No.: US 2008/0133088 A1
(43) Pub. Date: Jun. 5, 2008

(54) VEHICLE DATA RECORDER WITH VIDEO DISPLAY

(75) Inventor: MASAHIRO YAMADA, Tokyo (JP)

Correspondence Address: MAYER BROWN LLP, P.O. BOX 2828, CHICAGO, IL, 60690, US

(73) Assignee: Asahi Research Corporation, Tokyo (JP)

(21) Appl. No.: 11/743,954

(22) Filed: May 3, 2007

(30) Foreign Application Priority Data
Dec. 5, 2006 (JP) 2006-328505

(51) Int. Cl. G06F 19/00; B60R 1/02; H04N 7/18

(52) U.S. Cl. 701/46

(57) ABSTRACT

A vehicle data recorder according to an embodiment of the present invention comprises a processor, a power supply, a program memory for storing directions to be executed by the processor, a video camera for recording video data, a random-access memory for storing video data received from the video camera in a continuous-loop fashion, a non-volatile memory for storing video data from the random-access memory in response to a triggering event, a first sensor for detecting a triggering event, and a video display, wherein the video display displays video stored in the non-volatile memory, and wherein the vehicle data recorder is detachable from the motor vehicle and is capable of playing back video stored in the non-volatile memory while detached from the motor vehicle.

### FIELD OF THE INVENTION

The present invention generally relates to a vehicle data recorder. More particularly, the present invention relates to a vehicle data recorder that continuously records vehicle data, primarily video and audio data, for review at a later time.

### BACKGROUND OF THE INVENTION

A vehicle data recorder is intended to record vehicle data during the time surrounding a triggering event, such as a collision. Vehicle data could include video and audio data, as well as data collected from various sensors inside the vehicle, such as speed and RPM data. This vehicle data may later be used to reconstruct the circumstances surrounding the accident.

However, when using prior art vehicle data recorders, it is impossible to view the recorded vehicle data at the scene of the accident. This presents quick allocation of fault at the accident site by law enforcement officers. Further, the substantial time delay between the collision and the time when the recorded vehicle data is viewed raises the specter of modification of the recorded vehicle data.

Thus, there is a need for a vehicle data recorder with built-in playback capability. Further, there is a need for a vehicle data recorder with built-in playback capability that is capable of playing back video data when removed from the vehicle.

Accordingly, it is desirable to provide a vehicle data recorder with a built-in display, capable of operation when removed from the vehicle.

### SUMMARY OF THE INVENTION

A vehicle data recorder according to an embodiment of the present invention comprises a processor, a power supply, a program memory for storing directions to be executed by the processor, a video camera for recording video data, a random-access memory for storing video data received from the video camera in a continuous-loop fashion, a non-volatile memory for storing video data from the random-access memory in response to a triggering event, a first sensor for detecting a triggering event, and a video display, wherein the video display displays video stored in the non-volatile memory, and wherein the vehicle data recorder is detachable from the motor vehicle and is capable of playing back video stored in the non-volatile memory while detached from the motor vehicle.

### BRIEF DESCRIPTION OF THE DRAWINGS

In describing the preferred embodiments, reference is made to the accompanying drawing figures wherein like parts have like reference numerals, and wherein:

FIG. 1 is a block diagram of an embodiment of the present invention;

FIG. 2 is a flow chart illustrating the operation of an embodiment of the present invention; and

FIGS. 3 and 4 are perspective views of an embodiment of the present invention.

### DETAILED DESCRIPTION OF THE INVENTION

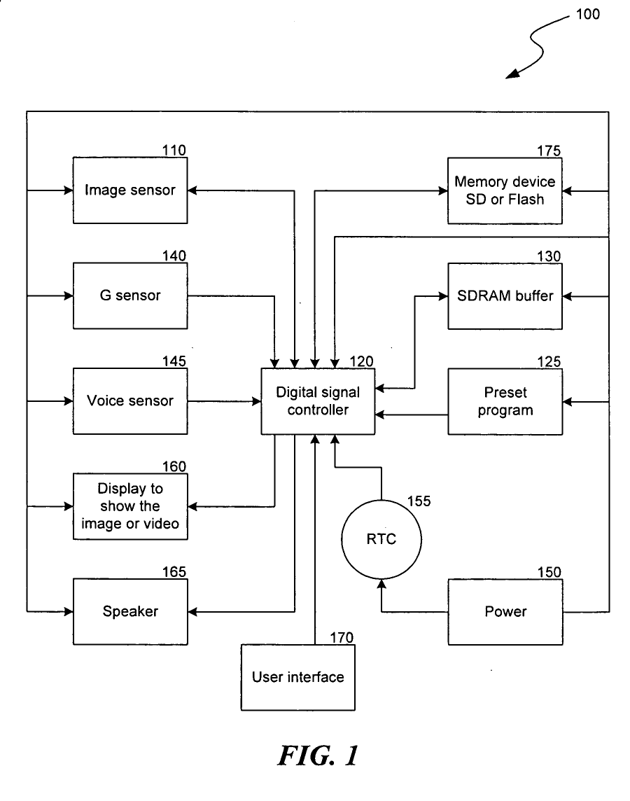

Referring generally to FIG. 1, and upon review of this description, it will be appreciated that the apparatus of the present invention generally may be embodied within numerous configurations.

FIG. 1 is a block diagram of a vehicle data recorder 100 according to an embodiment of the present invention. It comprises a video camera 110, signal controller 120, program memory 125, random-access memory (RAM) 130, non-volatile memory 135, g-force sensor 140, microphone 145, power supply 150, clock 155, display 160, speaker 165, user interface 170 and non-volatile memory 175.

Video camera 110 is mounted in the vehicle data recorder 100. Video camera 110 preferably looks towards the front of the vehicle being monitored, viewing in the direction of travel of the vehicle. Video camera 110 preferably utilizes a CCD or CMOS sensor. The vehicle data recorder 100 may include a plurality of video cameras 110.

Signal controller 120 is a microprocessor, microcontroller, or similar device. Signal controller 120 performs operations stored in the program memory 125. These operations will be discussed in greater detail below.

Program memory 125 stores operations to be performed by the signal controller 120. These operations will be discussed elsewhere in the specification.

Random-access memory (RAM) 130 is used for temporary storage of recorded vehicle data. It may additionally be used to store other information required in the operation of vehicle data recorder 100.

G-force sensor 140 is a device used to measure g-forces. G-force sensor 140 is typically an accelerometer. G-force sensor 140 may only be able to measure g-forces on a single axis. In this case, it may be advisable to use two g-force sensors 140, one measuring forward g-forces, the other measuring lateral g-forces. A third g-force sensor 140 may be utilized to measure vertical g-forces, but generally is not required.

Microphone 145 is used to pick up sounds audible inside the vehicle. For instance, the microphone would be able to pick up the voices of the driver and any passengers, tire screeches, horns, sirens, and collisions.

Power supply 150 supplies power to the various components of vehicle data recorder 100. Preferably, power supply 150 consists of a battery or batteries. This allows the vehicle data recorder 100 to be operated outside the vehicle. Alternatively, power supply 150 may draw power from the vehicle's power supply and distribute that power to the components of the vehicle date recorder 110. Vehicle data recorder 100 also preferably includes means to charge power supply 150, if power supply 150 is a battery, not shown here.

Real-time clock 155 supplies a clock signal to, at least, signal controller 120. Various other components may also require a clock signal. For instance, RAM 130 may require a clock signal.

Display 160 is used to display recorded video vehicle data. In other words, display 160 displays the vehicle data recorded by the video camera 10. Display 160 may also be used to display, for instance, menus allowing configuration of the vehicle data recorder 100 and data concerning the status of the vehicle data recorder 100.

Speaker 165 is used to play recorded audio vehicle data. Thus, speaker 165 plays the vehicle data recorded by the microphone 145.

User interface 170 is a set of controls that allow the user to configure the vehicle data recorder 100. The user interface may also be used to control the replay of vehicle data stored in RAM 130 or non-volatile memory 175. The user interface 170 preferably includes controls to play, stop, pause, fast-forward, rewind, step forward and step back.

Non-volatile memory 175 is used to more permanently store vehicle data of interest. Preferably, non-volatile storage 175 is a removable SD or CF flash memory card. Alternatively, vehicle data recorded 100 may employ two non-volatile memories 175, one permanent and internal to the vehicle data recorder 100, and one removable.

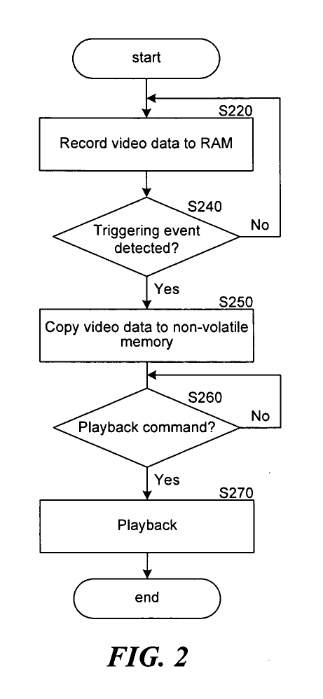

The operation of the vehicle data recorder 100 will now be described with reference to FIG. 2. At step S220, under control of the signal processor 110, digital signals representing the video recorded by video camera 110 and audio recorded by microphone 145 are recorded to RAM 130, configured as a continuous loop buffer. In other words, vehicle data is stored in RAM 130 until a predetermined amount of RAM 130 is used to store the vehicle data. At that point, the earliest-recorded vehicle information is overwritten. RAM 130 is configured to store a predetermined amount of vehicle data such as, for instance, 128 megabytes. It will be apparent to those of skill in the art that the period of time reflected by the vehicle data stored in RAM 130 will vary depending on the video and audio quality, level of compression, if any, the number of video cameras 110 and microphones 145, and the amount of memory in RAM 130 configured to store vehicle data. In a preferred embodiment, it is desired that at least 15 seconds of video be stored at all times. The vehicle data stored in RAM 130 is preferably time-stamped.

During normal operation of the vehicle data recorder 100, S240 will evaluate as no, and the vehicle data recorder 100 will continuously record vehicle data to the RAM 130.

However, when a triggering event occurs S240 evaluates to yes, and operation proceeds to S250. At S250, the signal controller 110 copies the vehicle data stored in the RAM 130 to the non-volatile memory 175. Typically, the triggering event is the detection by the g-force sensor 140 of acceleration data indicating that a collision has occurred. Alternatively, the triggering event may be the detection by microphone 145 of audio data indicating a collision or some other interesting event had occurred. In another embodiment, the signal controller 110 may delay the transfer of vehicle data stored in the RAM 130 to the non-volatile memory 175 for a predetermined period of time, such as five seconds. In the meantime, vehicle data would continue to be recorded in the RAM 130. In this way, not only the events immediately preceding the triggering event but also the events shortly thereafter may be committed to non-volatile memory 175.

RAM 130 and non-volatile memory 175 thus together form a two tiered memory structure. RAM 130 records vehicle data in a continuous fashion. Upon the occurrence of a triggering event, the vehicle data stored in RAM 130 is copied to non-volatile memory 175. The vehicle data thus stored in non-volatile memory 175 is then not deleted unless explicitly requested by a user. Preferably, non-volatile memory 175 should have the capacity to store vehicle data relating to several triggering events.

Shortly after the occurrence of a triggering event, a user may desire to play back the stored vehicle data. If the user issues a playback command at S260, the vehicle data stored in non-volatile memory 175 may be replayed through display 160 and speaker 165 at S270. The playback is preferably controlled through the user interface 170.

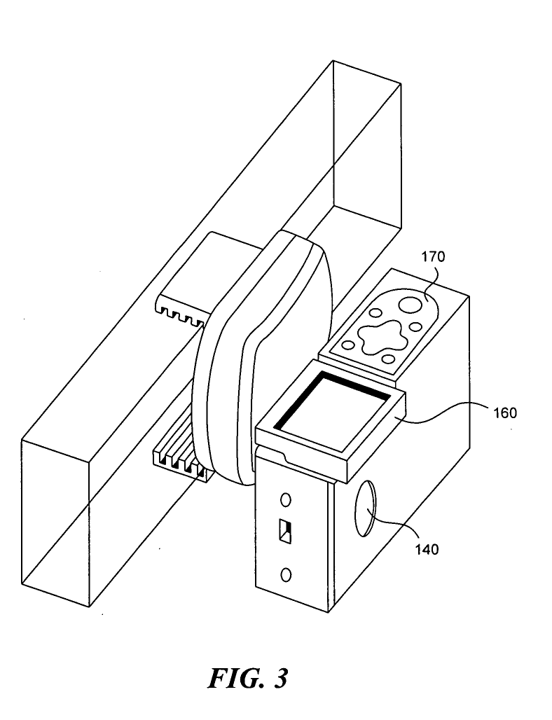

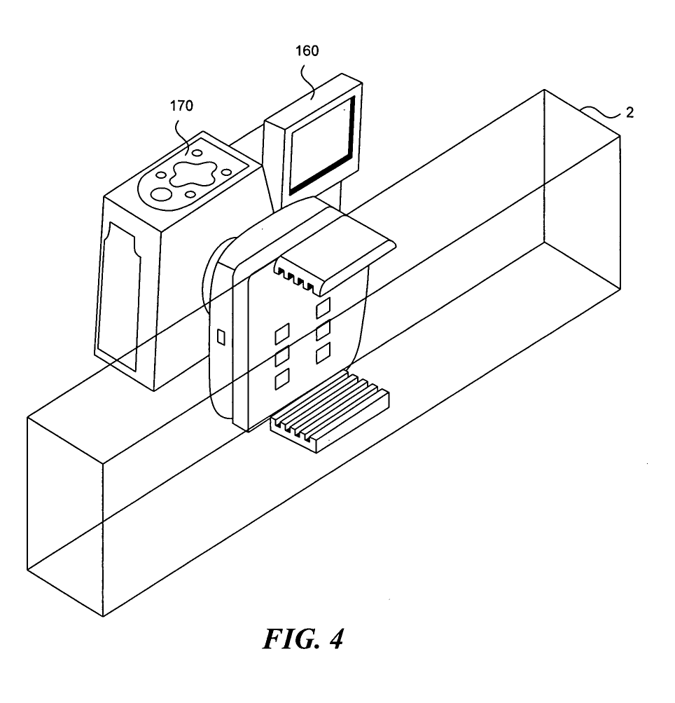

FIGS. 3 and 4 illustrate an embodiment of the vehicle data recorder 100 as a mount for a rear-view mirror. The vehicle data recorder 100 attaches to the windshield, and holds a rear-view mirror 2. The video camera 170 is located on the front surface of the vehicle data recorder 100, and has a field of vision outside the front. The display 160 is rotatably mounted to the bottom surface of the vehicle data recorder 100, and is able to be flipped so that it is facing the cabin, as illustrated in FIG. 4. User interface 170 is shown located on the top surface of vehicle data recorder 170.

It should be appreciated that merely preferred embodiments of the invention have been described above. However, many modifications and variations to the preferred embodiments will be apparent to those skilled in the art, which will be within the spirit and scope of the invention. For instance, although the above description of preferred embodiments discussed ties in the traditional rectangular shape, Therefore, the invention should not be limited to the described embodiments. To ascertain the full scope of the invention, the following claims should be referenced.

What is claimed is:

1. A vehicle safety system comprising:
a vehicle data recorder detachable from a motor vehicle and capable of playing back video stored in a non-volatile memory while detached from the motor vehicle comprising:
a processor;
a power supply;
a program memory storing instructions to be executed by the processor;
a video camera for recording video data;
a random-access memory configured to store video data received from the video camera in a continuous-loop fashion;
a non-volatile memory configured to store video data from the random-access memory in response to a triggering event;
a first sensor configured to detect a triggering event; and
a video display configured to display video stored in the non-volatile memory.

2. The vehicle safety system of claim 1, wherein the vehicle data recorder further comprises a clock configured to supply a clock signal to the processor.

3. The vehicle safety system of claim 1, wherein the power supply is a battery.

4. The vehicle safety system of claim 1, wherein the sensor is a g-force sensor.

5. The vehicle safety system of claim 4, wherein the vehicle data recorder further comprises a second g-force sensor aligned on a sensing axis substantially perpendicular to a sensing axis of the first sensor.

6. The vehicle safety system of claim 1, wherein the vehicle data recorder further comprises a user interface.

7. The vehicle safety system of claim 1, wherein the vehicle data recorder is adapted to be attached to a windshield of an automobile.

8. The vehicle safety system of claim 7, wherein the vehicle data recorder further comprises an adjustable rear-view mirror.

9. The vehicle safety system of claim 8, wherein the surface of the rear-view mirror is used as the video display.

10. The vehicle safety system of claim 1, wherein the vehicle data recorder further comprises a speaker.

11. The vehicle safety system of claim 10, wherein the vehicle data recorder further comprises a microphone.

12. The vehicle safety system of claim 1, wherein the sensor is a sound trigger.

13. The vehicle safety system of claim 1, wherein the sensor is a manual switch.
